(19) United States
(12) Patent Application Publication
(10) Pub. No.: US 2018/0123735 A1
(43) Pub. Date: May 3, 2018

(54) ERROR LIMITING METHOD, ERROR LIMITER AND DIGITAL RECEIVING CIRCUIT

(71) Applicant: MStar Semiconductor, Inc., Hsinchu Hsien (TW)

(72) Inventors: CHIA-WEI CHEN, Hsinchu Hsien (TW); KAI-WEN CHENG, Hsinchu Hsien (TW); KO-YIN LAI, Hsinchu Hsien (TW)

(21) Appl. No.: 15/795,659

(22) Filed: Oct. 27, 2017

(30) Foreign Application Priority Data
Nov. 3, 2016 (TW) 105135680

(51) Int. Cl. H04L 1/00; H04B 1/10; G06F 11/07

(52) U.S. Cl. CPC H04L 1/0061; G06F 11/0751; H04B 1/1036

(57) ABSTRACT

An error limiting method includes: receiving a first signal and a first error signal, wherein the first error signal is associated with the first signal and a first symbol corresponding to the first signal; calculating a first magnitude value of the first signal; and decreasing an error energy of the first error signal according to the first magnitude value of the first signal to generate a second error signal, and outputting the second error signal to an error feedback circuit.

This application claims the benefit of Taiwan application Serial No. 105135680, filed Nov. 3, 2016, the subject matter of which is incorporated herein by reference.

### BACKGROUND OF THE INVENTION

### Field of the Invention

The invention relates in general to an error limiting method, an error limiter and a digital receiving circuit, and more particularly to an error limiting method, an error limiter and a digital receiving circuit capable of determining the amount of reduction for a magnitude of an error energy according to an arrangement density of constellation points.

### Description of the Related Art

Adaptive filters are extensively applied in digital communication systems. When an adaptive filter converges to a stable state, any sudden disturbances may cause an increased error, and additional convergence time is needed for the adaptive filter to again converge to a stable state, hence resulting in degraded system performance. In the above situation, an error limiter may be applied to prevent negative influences that the instantaneous disturbances pose on the system performance.

To accommodate the ever-increasing transmission speed demanded for communication systems, new-generation communication systems (e.g., a DVB S2X digital television system, an extension of Digital Video Broadcasting-Satellite Generation 2) adopt high-level modulation schemes or irregular modulation schemes to modulate signals (e.g., 256 amplitude and phase-shift keying (256APSK)), and corresponding constellation points may have different amplitudes and may be arranged in a plurality of rings. However, a conventional error limiter is designed for modulation schemes corresponding to constellation points arranged in one single ring (i.e., pure phase-shift keying (PSK), such as QPSK or 8PSK) instead of also considering situations where constellation points are arranged in a plurality of rings. Thus, such conventional error limiter brings limited improvement for the situation above.

Therefore, there is a need for a solution that overcomes the foregoing issue.

### SUMMARY OF THE INVENTION

The invention is directed to an error limiting method, an error limiter and a digital receiving circuit capable of determining the amount of reduction for a magnitude of an error energy according to an arrangement density of constellation points to improve the issue of the prior art.

The present invention discloses an error limiting method applied to an error limiter of a digital receiving circuit. The error limiting method includes: receiving a first signal and a first error signal, wherein the first error signal is associated with the first signal and a first symbol corresponding to the first signal; calculating a first magnitude value of the first signal; and decreasing an error energy of the first error signal according to the first magnitude value of the first signal to generate a second error signal. The error limiter outputs the second error signal to an error feedback circuit of the digital receiving circuit.

The present invention further discloses an error limiter applied to a digital receiving circuit. The error limiter includes: a magnitude circuit, receiving a first signal and generating a first magnitude value of the first signal; and a limiting circuit, coupled to the magnitude circuit, receiving the first error signal and the first magnitude value, decreasing an error energy of the first error signal according to the first magnitude value of the first signal to generate a second signal, and outputting the second error signal to an error feedback circuit of the digital receiving circuit. The first error signal is associated with the first signal and a first symbol corresponding to the first signal.

The present invention further discloses a digital receiving circuit. The digital receiving circuit includes: an error feedback circuit, outputting a first signal according to a plurality of coefficients; a symbol decision circuit, coupled to the error feedback circuit, outputting a first symbol corresponding to the first signal according to the first signal; a subtraction circuit, coupled to the symbol decision circuit, generating a first error signal according to the first signal and the first symbol; and an error limiter, coupled to the symbol decision circuit, the subtraction circuit and the error feedback circuit, including a magnitude circuit that receives the first signal and generates a first magnitude value of the first signal, and a limiting circuit that is coupled to the subtraction circuit and the magnitude circuit, receives the first error signal and the first magnitude value, decreases an error energy of the first error signal according to the first magnitude value of the first signal to generate a second error signal, and outputs the second error signal to the error feedback circuit. The error feedback circuit adjusts the plurality of coefficients according to the second error signal.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a digital receiving circuit according to an embodiment of the present invention;

FIG. 2 is a block diagram of an error limiter according to an embodiment of the present invention;

FIG. 3 is a schematic diagram of a modulation scheme on a constellation plane;

FIG. 4 is a schematic diagram of a pseudo code according to an embodiment of the present invention;

FIG. 5 is a schematic diagram of a modulation scheme and circular regions;

FIG. 6 is a schematic diagram of a pseudo code according to an embodiment of the present invention;

FIG. 7 is a flowchart of an error limiting process according to an embodiment of the present invention;

FIG. 8 is a block diagram of a digital receiving circuit according to an embodiment of the present invention;

FIG. 9 is a schematic diagram of a pseudo code according to an embodiment of the present invention; and

FIG. 10 is a block diagram of a limiting circuit according to an embodiment of the present invention.

### DETAILED DESCRIPTION OF THE INVENTION

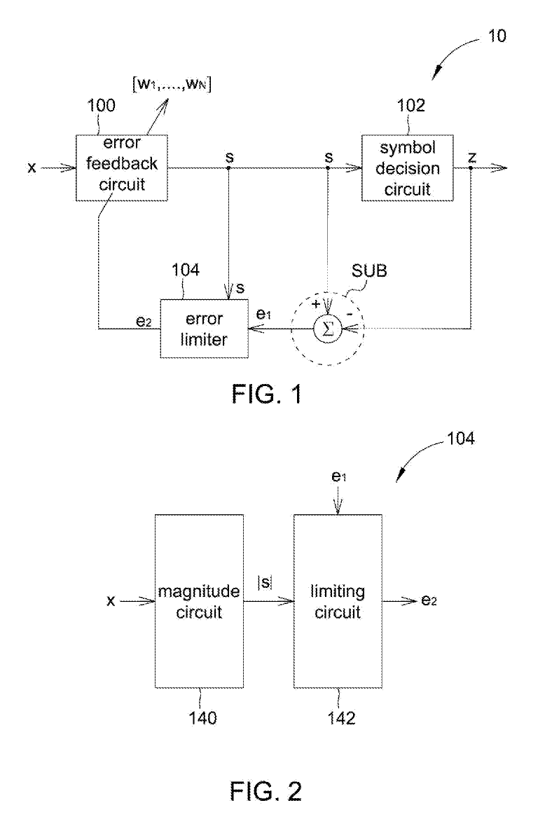

FIG. 1 shows a block diagram of a digital receiving circuit 10 according to an embodiment of the present invention. As shown in FIG. 1, the digital receiving circuit 10 includes an error feedback circuit 100, a symbol decision circuit 102, an error limiter 104 and a subtraction circuit SUB. The error feedback circuit 100 includes an adaptive filter (not shown) that processes a signal x, i.e., processing a signal x according to coefficients w₁ to w_{N}, to output a first signal s. The first signal s includes a signal modulated by amplitude phase-shift keying (APSK) and a noise. The symbol decision circuit 102 is a slicer coupled to the error feedback circuit 10, receives the first signal s, and determines a first symbol z corresponding to the first signal s according to the first signal s. The subtraction circuit SUB, coupled to the error feedback circuit 100 and the symbol decision circuit 102, generates a first error signal e₁. The error limiter 104, coupled to the symbol decision circuit 102, the subtraction circuit SUB and the error feedback circuit 100, limits a size of an error of an error signal (i.e., selectively decreasing an error energy eng₁ of the first error signal e₁, where the error energy eng₁ may be represented as eng₁=|e₁|²), so as to prevent the error feedback circuit 100 from an excessively long convergence time due to a larger error signal and hence from degrading system performance. In other words, the error limiter 104 may adjust the first error signal e₁ according to the first signal s to generate a second error signal e₂, and output the second error signal e₂ to the error feedback circuit 100. Further, the error limiter 104 may determine an adjustment level of the first error signal e₁ (i.e., determining the amount of reduction for the error energy eng₁) according to an amplitude/magnitude of the first signal s to generate the second error signal e₂. Thus, the error feedback circuit 100 may adjust the coefficients w₁ to w_{N} according to the second error signal e₂ to generate the first signal s. In one embodiment, the first error signal e₁ may be a subtraction result of the first signal s and the first symbol z (i.e., e₁=s−z), the error feedback circuit 100 may be a feed-forward equalizer (FFE), and the digital receiving circuit 10 is correspondingly an equalization circuit.

FIG. 2 shows a block diagram of the error limiter 104 according to an embodiment of the present invention. Referring to FIG. 2 showing the detailed structure of the error limiter 104, the error limiter 104 includes a magnitude circuit 140 and a limiting circuit 142. The magnitude circuit 140 receives the first signal s, and generates a first magnitude value of the first signal s to the limiting circuit 142. The limiting circuit 142, coupled to the magnitude circuit 140 and the subtraction circuit SUB, receives the first magnitude value and the first error signal e₁, and adjusts the first error signal e₁ according to the first magnitude value |s| to generate the second error signal e₂.

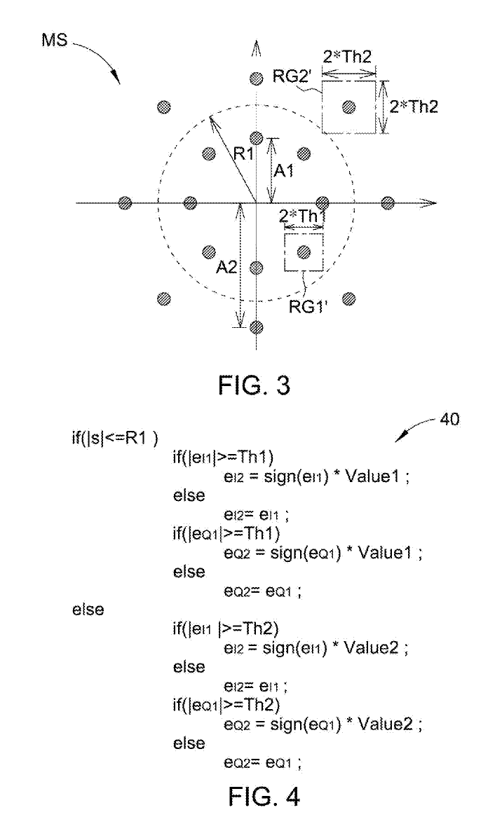

FIG. 3 shows a schematic diagram of a modulation scheme MS on a constellation plane. As shown in FIG. 3, the modulation scheme MS is 16APSK and includes 16 constellation points. Among the 16 constellation points, 8 constellation points are arranged into a first ring having a first amplitude A1, while the remaining 8 constellation points are arranged into a second ring having a second amplitude A2 that is greater than the first amplitude A1. Because the second amplitude A2 is greater than the first amplitude A1, the 8 constellation points having the first amplitude A1 are arranged more densely, and the 8 constellation points having the second amplitude A2 are arranged more sparsely. Given that the first signal s includes a signal modulated by the modulation scheme MS, the limiting circuit 142 may first determine whether the first magnitude value |s| is smaller than or greater than a predetermined value R1. In one embodiment, when the limiting circuit 142 determines that the magnitude value |s| is smaller than or equal to the predetermined value R1 (i.e., when the first magnitude value |s| is in a first interval IVL1, which may be presented as IVL1={t≥0|t≤R1}), the limiting circuit 142 adjusts the first error signal e₁ (i.e., selectively decreasing the error energy eng₁ of the first error signal e₁) according to a first threshold Th1 to generate the second error signal e₂; when the limiting circuit 142 determines that the magnitude value |s| is greater than the predetermined value R1 (i.e., when the first magnitude value |s| is in a second interval IVL2, which may be represented as IVL2={t≥0|t≥R1}), the limiting circuit 142 adjusts the first error signal e₁ according to a second threshold Th2 (i.e., selectively decreasing the error energy eng₁ of the first error signal e₁) to generate the second error signal e₂. The first interval IVL1 and the second interval IVL2 are mutually exclusive intervals.

Preferably, the predetermined value R1 may be an average of the first amplitude A1 and the second amplitude A2. For example, the predetermined value R1 may be R1=(A1+A2)/2. Further, the values of the first threshold Th1 and the second threshold Th2 may be adjusted according to the density of the constellation points in the ring. For example, when the 8 constellation points having the first amplitude A1 and forming the first ring are more densely arranged, the first threshold Th1 is in a smaller value; when the 8 constellation points having the second amplitude A2 and forming the second ring are more sparsely arranged, the second threshold Th2 is in a larger value.

More specifically, in one embodiment, the limiting circuit 142 may limit an error signal e₁ within a rectangular region. In other words, when the limiting circuit 142 determines that the first magnitude value |s| is in the first interval IVL1, the limiting circuit 142 limits the first error signal e₁ within a rectangular region RG1; i.e., the limiting circuit 142 generates the second error signal e₂ that is located in the rectangular region RG1. The rectangular region RG1 is in a complex plane, and may be represented as RG1={e∥Re(e)|≤Th1, |Im(e)|≤Th1}, where Re(⋅) is real-part operator, Im(⋅) is an imaginary-part operator, and e is a complex number. On the other hand, when the limiting circuit 142 determines that the first magnitude value |s| is in the second interval IVL2, the limiting circuit 142 limits the first error signal e₁ in a rectangular region RG2; i.e., the limiting circuit 142 generates the second error signal e₂ that is located in the rectangular region RG2. The rectangular region RG2 is in a complex plane, and may be represented as RG2={e∥Re(e)|≤Th2, |Im(e)|≤Th2}. Further, FIG. 3 depicts rectangular regions RG1′ and RG2′ as the rectangular regions RG1 and RG2 having been shifted, and constellation points respectively having the first amplitude A1 and the second amplitude A2 are the centers of the rectangular regions RG1′ and RG2′. Further, each element in the second interval IVL2 is greater than any element in the first interval IVL1. Preferably, the second threshold Th2 is greater than the first threshold Th1. Thus, when the first magnitude value |s| is in the first interval IVL1, from perspectives of statistics, the amount of reduction that the error limiter 104 applies on the error energy eng₁ is greater; when the first magnitude value |s| is in the second interval IVL2, from perspectives of statistics, the amount of reduction that the error limiter 104 applies on the error energy eng₁ is smaller.

More specifically, when the limiting circuit 142 determines that the first magnitude value |s| is in the first interval IVL1, the limiting circuit 142 further determines whether a first in-phase component of the first error signal e₁ or a first quadrature component e_{Q1} of the first error signal e₁ is greater than the first threshold Th1. When the limiting circuit 142 determines that the first in-phase component is greater than the first threshold Th1, the limiting circuit 142 may generate a second in-phase component e_{I2} of the second error signal e₂, such that an absolute value of the second in-phase component e_{I2} is smaller than or equal to the first threshold Th1; when the limiting circuit 142 determines that the first in-phase component is smaller than the first threshold Th1, the limiting circuit 142 may generate a second in-phase component e_{I2} that is equal to the first in-phase component e_{I1}. When the limiting circuit 142 determines that the first quadrature component e_{Q1} is greater than or equal to the first threshold Th1, the limiting circuit 142 may generate a second quadrature component e_{Q2} of the second error signal e₂, such that an absolute value of the second quadrature component e_{Q2} is smaller than or equal to the first threshold Th1; when the limiting circuit 142 determines that the first quadrature component e_{Q1} is smaller than the first threshold Th1, the limiting circuit 142 may generate the second quadrature component e_{Q2} that is equal to the first quadrature component e_{Q1}.

On the other hand, when the limiting circuit 142 determines that the first magnitude value |s| is in the second interval IVL2, the limiting circuit 142 further determines whether a first in-phase component e_{I1} of the first error signal e₁ or a first quadrature component e_{Q1} of the first error signal e₁ is greater than the second threshold Th2. When the limiting circuit 142 determines that the first in-phase component is greater than or equal to the second threshold Th2, the limiting circuit 142 may generate a second in-phase component e_{I2} of the second error signal e₂, such that an absolute value of the second in-phase component e_{I2} is smaller than or equal to the second threshold Th2; when the limiting circuit 142 determines that the first in-phase component is smaller than the second threshold Th2, the limiting circuit 142 may generate the second in-phase component e_{I2} that is equal to the first in-phase component e_{I1}. When the limiting circuit 142 determines that the first quadrature component e_{Q1} is greater than or equal to the second threshold Th2, the limiting circuit 142 may generate a second quadrature component e_{Q2} of the second error signal e₂, such that an absolute value of the second quadrature component e_{Q2} is smaller than or equal to the second threshold; when the limiting circuit 142 determines that the first quadrature component e_{Q1} is smaller than the second threshold Th2, the limiting circuit 142 may generate the second quadrature component e_{Q2} that is equal to the first quadrature component e_{Q1}.

Operation details of how the limiting circuit 142 limits the first error signal e₁ within the rectangular region may be represented as a pseudo code 40, as shown in FIG. 4. Referring to FIG. 4, the sign(⋅) represents a negative/positive sign operator, the value Value1 is smaller than or equal to the first threshold Th1, and the value Value2 is smaller than or equal to the second threshold Th2. Further, the value Value1 or the value Value2 may be 0.

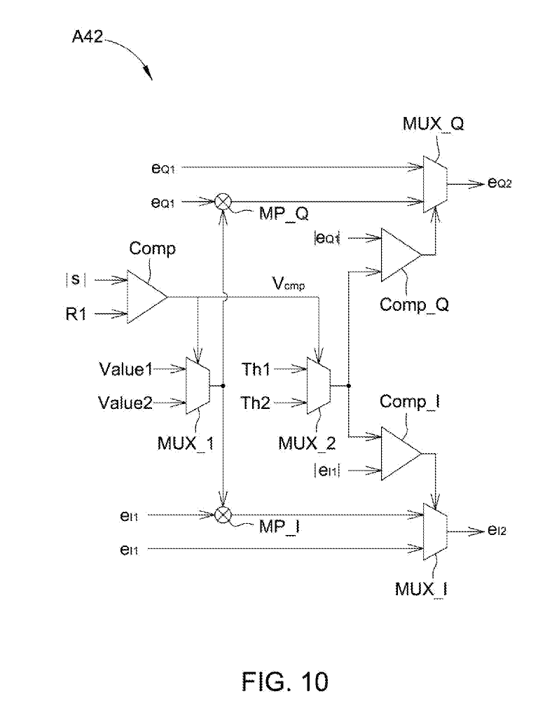

Further, the pseudo code 40 may be implemented by a circuit formed by comparators and multiplexers. For example, FIG. 10 shows a block diagram of a limiting circuit A42 according to an embodiment of the present invention. The limiting circuit A42 may realize the pseudo code 40, and includes comparators Comp, Comp_I and Comp_Q, multiplexers MUX_1, MUX_2, MUX_I and MUX_Q, and multipliers MP_I and MP_Q. The comparator Comp compares the first magnitude value |s| with the predetermined value R1 to generate a comparison result V_{cmp}. The multiplexer MUX_1 determines to output one of the value Value1 and the value Value2 according to the comparison result V_{cmp}. The multiplexer MUX_2 determines to output one of the first threshold Th1 and the second threshold Th2 according to the comparison result V_{cmp}. The limiting circuit A42 determines that the multiplier MP_I is to output a multiplication result of |e_{I1}| and the value Value1 or a multiplication result of and the value Value2 according to the comparison result V_{cmp}, and determines that the multiplier MP_Q is to output a multiplication result of |e_{Q1}| and the value Value1 or the a multiplication result of |e_{Q1}| and the value Value2. Further, the limiting circuit A42 determines to output one of the second in-phase component e_{I2} that is equal to the first in-phase component and the multiplication result of the multiplier MP_I through the multiplexer MUX_I according to the comparison result of the comparator Comp_I, and determines to output one of the second quadrature component e_{Q2} that is equal to the first quadrature component e_{Q1} and the multiplication result of the multiplier MP_Q through the multiplexer MUX_Q according to the comparison result of the comparator Comp_Q.

Thus, an error energy eng₂ of the second error signal e₂ generated by the error limiter 104 is smaller than or equal to the error energy eng₁ of the first error signal e₁ (the error energy eng₂ may be represented as eng₂=|e₂|²); that is, the error limiter 104 may selectively decrease the error energy eng₁ of the first error signal e₁. Further, the error limiter 104 may determine whether the first magnitude value |s| is in the first interval IVL1 or the second interval IVL2 according to the first magnitude value and determine the amount of reduction to be applied on the error energy eng₁ according to the determination result; that is, the first error signal e₁ is adjusted according to the first threshold Th1/the second threshold Th2 corresponding to the first interval IVL1/the second interval IVL2, to generate the second error signal e₂.

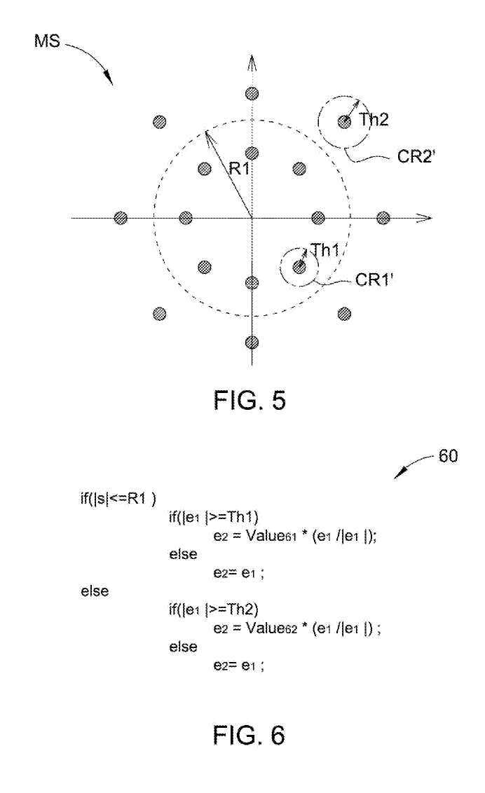

In one embodiment, the error limiter 142 may limit the first error signal e₁ within a circular region. In other words, when the limiting circuit 142 determines that the first magnitude value |s| is in the first interval IVL1, the limiting circuit 142 limits the first error signal e₁ within a circular region CR1; that is, the limiting circuit 142 generates the second error signal e₂ that is located in the circular region CR1. The circular region CR1 is in a complex plane, and may be represented as CR1={e∥e|≤Th1}, where |⋅| is a magnitude operator. On the other hand, when the limiting circuit 142 determines that the first magnitude value |s| is in the second interval IVL2, the limiting circuit 142 limits the first error signal e₁ within a circular region CR2; that is, the limiting circuit 142 generates the second error signal e₂ that is located within the circular region CR2. The circular region CR2 is in a complex plane, and may be represented as CR2={e∥e|≤Th2}. FIG. 5 shows a schematic diagram of the modulation scheme MS and circular regions CR1′ and CR2′. Similarly, the circular regions CR1′ and CR2′ are the circular regions CR1 and CR2 having been shifted, and the constellation points respectively having the first amplitude A1 and the second amplitude A2 are the centers of the circular regions CR1′ and CR2′.

More specifically, when the limiting circuit 142 determines that the first magnitude value |s| is in the first interval IVL1, the limiting circuit 142 further determines whether a first error magnitude value of |e₁| the first error signal e₁ is greater than the first threshold Th1. When the limiting circuit 142 determines that the first error magnitude value is greater than or equal to the first threshold Th1, the limiting circuit 142 may generate a second error magnitude value |e₂| of the second error signal e₂, such that the second error magnitude value |e₂| is smaller than or equal to the first threshold Th1; when the limiting circuit 142 determines that the first error magnitude value |e₁| is smaller than the first threshold Th1, the limiting circuit 142 may generate the second error signal e₂ that is equal to the first error signal e₁. On the other hand, when the limiting circuit 142 determines that the first magnitude value |s| is in the second interval IVL2, the limiting circuit 142 further determines whether a first error magnitude value of the first error signal e₁ is greater than the second threshold Th2. When the limiting circuit 142 determines that the first error magnitude value |e₁| is greater than the second threshold Th2, the limiting circuit 142 may generate a second error magnitude value |e₂| of the second error signal e₂, such that the second error magnitude value |e₂| is smaller than or equal to the second threshold Th2; when the limiting circuit 142 determines that the first error magnitude value |e₁| is smaller than the second threshold Th2, the limiting circuit 142 may generate the second error signal e₂ that is equal to the first error signal e₁.

Operation details of how the limiting circuit 142 limits the first error signal e₁ within a circular region may be represented as a pseudo code 60, as shown in FIG. 6. Referring to FIG. 6, a value Value61 is smaller than or equal to the first threshold Th1, and a value Value62 is smaller than or equal to the second threshold Th2. Both of the value Value61 and the value Value62 may represent the second magnitude value |e₂|, and may be 0. Similarly, the pseudo code 60 may be realized by a circuit similar to that in FIG. 10, and associated details are omitted herein.

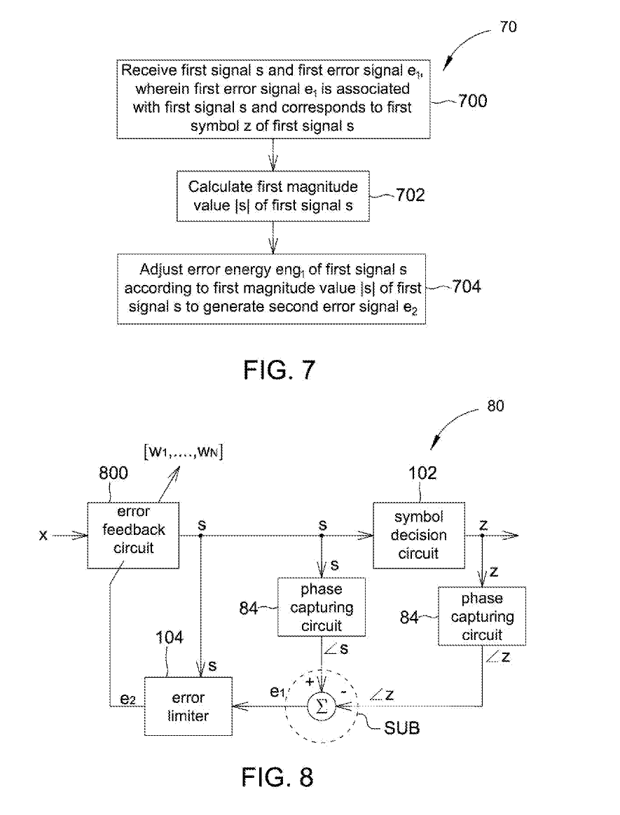

The operations of the error limiter 104 in FIG. 1 may be concluded into an error limiting process. FIG. 7 shows a flowchart of an error limiting process 70 according to an embodiment of the present invention. The error limiting process 70 may be performed by the error limiter 104 in FIG. 1, and includes following steps.

In step 700, the first signal s and the first error signal e₁ are received. The first error signal e₁ is associated with the first signal s and corresponds to the first symbol z of the first signal s.

In step 702, the first magnitude value of the first signal s is calculated.

In step 704, the error energy eng₁ of the first error signal e₁ is adjusted according to the first magnitude |s| value of the first signal s to generate the second error signal e₂.

Other details of the error limiting process 70 may be referred from associated description above, and shall be omitted herein.

It is known from the above description that, the error limiter 104 determines the amount of reduction to be applied on the error energy eng₁ according to the density of the constellation points, and the density of the constellation points is associated with the first magnitude value |s|. In other words, the error limiter 104 is capable of selectively adjusting the amount of reduction for the error energy eng₁ according to the value of the first magnitude value |s|. Compared to the prior art, the error limiter 104 is applicable to high-level APSK modulation systems in which the constellation points are arranged in a plurality of rings, and is capable of reducing the convergence time of the error feedback circuit 100 and enhancing the system performance of the digital receiving circuit 10.

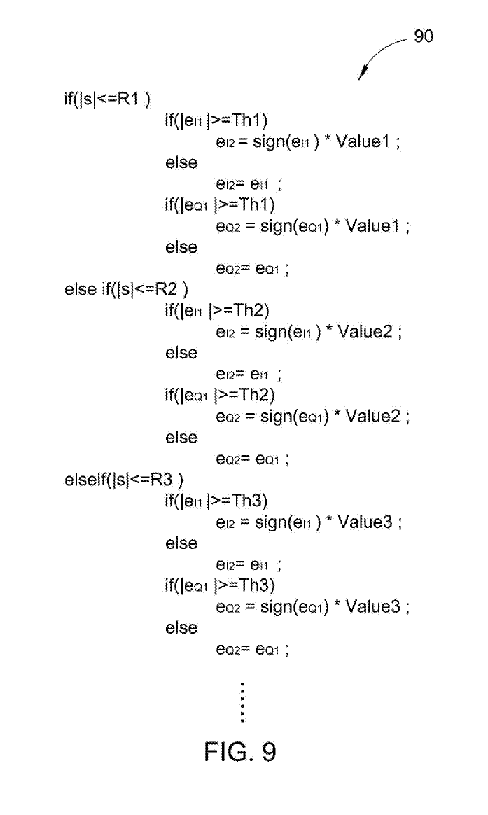

It should be noted that, the foregoing embodiments are for explaining the concept of the present invention, and one person skilled in the art may make modifications thereto. For example, when the first signal s includes a modulation signal of APSK of an even higher level (e.g., 256APSK), and the constellation points corresponding to the modulation scheme are arranged into M rings having different amplitudes (M>2), the operation details of the limiting circuit 142 may be represented as a pseudo code 90, as shown in FIG. 9. Referring to FIG. 9, Th3 represents a threshold corresponding to an interval IVL3 (which may be represented as IVL3={t≥0|R2<t≤R3}), and a value Value3 may be smaller than or equal to the threshold Th3. Similarly, the pseudo code 90 may be realized by a circuit similar to that in FIG. 10, and associated details are omitted herein. Further, given that the numbers of the constellation points of the individual rings are equal, the density between the constellation points is associated with the amplitude of the rings. As the amplitude of the rings gets larger, the constellation points are more sparsely arranged and the threshold corresponding to the rings also gets larger. As the amplitude of the rings gets smaller, the constellation points are more densely arranged and the threshold corresponding to the rings also gets smaller.

Further, the error feedback circuit of the digital receiving circuit may also be a phase recovery circuit instead of the foregoing feed-forward equalizer. FIG. 8 shows a block diagram of a digital receiving circuit 80 according to an embodiment of the present invention. The digital receiving circuit 80 is similar to the digital receiving circuit 10, and the same elements are similarly denoted. One difference of the digital receiving circuit 80 from the digital receiving circuit 10 is that, the digital receiving circuit 80 includes an error feedback circuit 800 and phase capturing circuits 82 and 84. The error feedback circuit 800 is a phase recovery circuit, and an error signal e is a subtraction result between a phase Zs of the first signal s and a phase ∠z of the first symbol z (i.e., e=∠s−∠z). The requirement of the present invention is satisfied given that the error feedback circuit 100 adjusts the coefficients w₁ to w_{N} of its filter according to the error signal e.

One person skilled in the art can understand that, the function units/circuits in FIG. 1, FIG. 2 and FIG. 8 may be realized or implemented by digital circuits (e.g., an RTL circuit) or digital signal processors (DSP), and associated details are omitted herein.

In summary, in the present invention, the amount of reduction applied on the error energy is determined according to the first magnitude value of the first signal. Compared to the prior art, the present invention is applicable to high-level modulation systems having a plurality of rings, and is capable of reducing the convergence time of the error feedback circuit and enhancing the system performance of the digital receiving circuit.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An error limiting method, applied to an error limiter of a digital receiving circuit, the error limiting method comprising:
receiving a first signal and a first error signal, wherein the first error signal is associated with the first signal and a first symbol corresponding to the first signal;
calculating a first magnitude value of the first signal; and
adjusting an error energy of the first error signal according to the first magnitude value of the first signal to generate a second error signal;
wherein, the error limiter outputs the second error signal to an error feedback circuit of the digital receiving circuit.

2. The error limiting method according to claim 1, wherein the step of generating the second error signal according to the first magnitude value of the first signal comprises:
determining whether the first magnitude value is in an interval among a plurality of intervals, wherein the plurality of intervals correspond a plurality of thresholds that are not entirely equal; and
when the first magnitude value is in a first interval among the plurality of intervals, generating the second error signal according to the first error signal and a first threshold among a plurality of thresholds that corresponds to the first interval.

3. The error limiting method according to claim 2, wherein when the first magnitude value is in the first interval, the step of generating the second error signal according to the first error signal and the first threshold comprises:
determining whether a first in-phase component of the first error signal or a first quadrature component of the first error signal is greater than the first threshold;
when the first in-phase component is greater than the first threshold, generating a second in-phase component of the second error signal, wherein an absolute value of the second in-phase component is smaller than or equal to the first threshold; and
when the first quadrature component is greater than the first threshold, generating a second quadrature component of the second error signal, wherein an absolute value of the second quadrature component is smaller than or equal to the first threshold.

4. The error limiting method according to claim 3, wherein when the first magnitude value is in the first interval, the step of generating the second error signal according to the first error signal and the first threshold comprises:
when the first in-phase component is smaller than the first threshold, generating the second in-phase component that is equal to the first in-phase component; and
when the first quadrature component is smaller than the first threshold, generating the second quadrature component that is equal to the first quadrature component.

5. The error limiting method according to claim 2, wherein when the first magnitude value is in the first interval, the step of generating the second error signal according to the first error signal and the first threshold comprises:
determining whether a first error magnitude value of the first error signal is greater than the first threshold; and
when the first error magnitude value is greater than the first threshold, generating a second error magnitude value of the second error signal, wherein the second error magnitude value is smaller than or equal to the first threshold.

6. The error limiting method according to claim 5, wherein when the first magnitude value is in the first interval, the step of generating the second error signal according to the first error signal and the first threshold comprises:
when the first error magnitude value is smaller than the first threshold, generating the second error signal that is equal to the first error signal.

7. The error limiting method according to claim 2, wherein the plurality of intervals comprise a second interval and a third interval, each element in the third interval is greater than any element in the second interval, and a third threshold corresponding to the third interval is greater than a second threshold corresponding to the second interval.

8. The error limiting method according to claim 1, wherein the first error signal is a subtraction result of the first signal and the first symbol.

9. The error limiting method according to claim 1, wherein the first error signal is a subtraction result of a phase of the first signal and a phase of the first symbol.

10. An error limiter, applied to a digital receiving circuit, the error limiter comprising:
a magnitude circuit, receiving a first signal, and generating a first magnitude value of the first signal;
a limiting circuit, coupled to the magnitude circuit, receiving a first error signal and the first magnitude value, adjusting an error energy of the first error signal according to the first magnitude value of the first signal to generate a second error signal, and outputting the second error signal to an error feedback circuit of the digital receiving circuit;
wherein, the first error signal is associated with the first signal and a first symbol corresponding to the first signal.

11. The error limiter according to claim 10, wherein the limiting circuit generates the second error signal according to the first magnitude value of the first signal by performing steps of:
determining whether the first magnitude value is in an interval among a plurality of intervals, wherein the plurality of intervals correspond a plurality of thresholds that are not entirely equal; and
when the first magnitude value is in a first interval among the plurality of intervals, generating the second error signal according to the first error signal and a first threshold among a plurality of thresholds that corresponds to the first interval.

12. The error limiter according to claim 11, wherein when the first magnitude value is in the first interval, the limiting circuit generates the second error signal according to the first error signal and the first threshold by performing steps of:
determining whether a first in-phase component of the first error signal or a first quadrature component of the first error signal is greater than the first threshold;
when the first in-phase component is greater than the first threshold, generating a second in-phase component of the second error signal, wherein an absolute value of the second in-phase component is smaller than or equal to the first threshold; and
when the first quadrature component is greater than the first threshold, generating a second quadrature component of the second error signal, wherein an absolute value of the second quadrature component is smaller than or equal to the first threshold.

13. The error limiter according to claim 12, wherein when the first magnitude value is in the first interval, the limiting circuit generates the second error signal according to the first error signal and the first threshold by performing steps of:
when the first in-phase component is smaller than the first threshold, generating the second in-phase component that is equal to the first in-phase component; and
when the first quadrature component is smaller than the first threshold, generating the second quadrature component that is equal to the first quadrature component.

14. The error limiter according to claim 11, wherein when the first magnitude value is in the first interval, the limiting circuit generates the second error signal according to the first error signal and the first threshold by performing steps of:
determining whether a first error magnitude value of the first error signal is greater than the first threshold; and
when the first error magnitude value is greater than the first threshold, generating a second error magnitude value of the second error signal, wherein the second error magnitude value is smaller than or equal to the first threshold.

15. The error limiter according to claim 14, wherein when the first magnitude value is in the first interval, the limiting circuit generates the second error signal according to the first error signal and the first threshold by performing a step of
when the first error magnitude value is smaller than the first threshold, generating the second error signal that is equal to the first error signal.

16. The error limiter according to claim 11, wherein the plurality of intervals comprise a second interval and a third interval, each element in the third interval is greater than any element in the second interval, and a third threshold corresponding to the third interval is greater than a second threshold corresponding to the second interval.

17. A digital receiving circuit, comprising:
an error feedback circuit, outputting a first signal according to a plurality of coefficients;
a symbol decision circuit, coupled to the error feedback circuit, outputting a first symbol corresponding to the first signal according to the first signal;
a subtraction circuit, coupled to the symbol decision circuit, generating a first error signal according to the first signal and the first symbol; and
an error limiter, coupled to the symbol decision circuit, the subtraction circuit and the error feedback circuit, comprising:
a magnitude circuit, receiving a first signal, and generating a first magnitude value of the first signal; and
a limiting circuit, coupled to the subtraction circuit and the magnitude circuit, receiving the first error and the first magnitude value, adjusting an error energy of the first error signal according to the first magnitude value of the first signal to generate a second error signal, and outputting the second error signal to the error feedback circuit;
wherein, the error feedback circuit adjusts the plurality of coefficients according to the second error signal.

18. The digital receiving circuit according to claim 17, wherein the error limiter generates the second error signal according to the first magnitude value of the first signal by performing steps of:
determining whether the first magnitude value is in an interval among a plurality of intervals, wherein the plurality of intervals correspond a plurality of thresholds that are not entirely equal; and
when the first magnitude value is in a first interval among the plurality of intervals, generating the second error signal according to the first error signal and a first threshold among a plurality of thresholds that corresponds to the first interval.

19. The digital receiving circuit according to claim 18, wherein the error feedback circuit is a feed-forward equalizer, and the first error signal that the subtraction circuit generates is a subtraction result of the first signal and the first symbol.

20. The digital receiving circuit according to claim 18, wherein the error feedback circuit is a phase recovery circuit, and the first error signal that the subtraction circuit generates is a subtraction result of a phase of the first signal and a phase of the first symbol.
